(19) United States
(12) Patent Application Publication
(10) Pub. No.: US 2007/0101667 A1
(43) Pub. Date: May 10, 2007

(54) Storm panel bracket system

(76) Inventors: William C. Sweet JR., Fern Park, FL (US); Robert F. Gerety, Orlando, FL (US)

Correspondence Address: LITMAN LAW OFFICES, LTD., P.O. BOX 15035, CRYSTAL CITY STATION, ARLINGTON, VA, 22215, US

(21) Appl. No.: 11/582,369

(22) Filed: Oct. 18, 2006

Related U.S. Application Data
(60) Provisional application No. 60/733,177, filed on Nov. 4, 2005.

(51) Int. Cl. E06B 3/26

(52) U.S. Cl. 52/202

(57) ABSTRACT

The storm panel bracket system secures storm panels inset within the frame of building openings. The storm panel bracket system includes one or more storm brackets and one or more resilient bumpers. Each storm bracket includes an adjusting screw and adjustment nut. Turning the adjustment nut moves the nut along the adjusting screw. The moving nut moves a movable member of the storm bracket. The movable member holds a protecting storm panel and forces the panel against the frame of the window, providing a press fit that holds the storm panel in place. The storm panel bracket system includes resilient bumpers that are placed between the storm panel and the frame to cushion the frame and enhance friction.

### CROSS-REFERENCE TO RELATED APPLICATION

This application claims the benefit of U.S. Provisional Patent Application Ser. No. 60/733,177, filed Nov. 4, 2005.

### BACKGROUND OF THE INVENTION

1. Field of the Invention

The present invention relates to devices for the protection of buildings from storm damage, and more particularly to a storm panel bracket system for securing storm panels to building openings for the prevention of damage caused by high-speed winds, such as hurricane force winds.

2. Description of the Related Art

Hurricanes and other tropical storms generate high-speed winds that can cause extensive damage to buildings. The most vulnerable areas of most buildings are the windows and doors. Glass covered windows and doors are easily damaged by winds and windborne debris. When glass is broken during a windstorm, the resulting glass fragments and shards become dangerous projectiles that can cause damage to the building contents, and serious injury to any occupants within the building. In addition, once the glass is broken, the integrity of the window or door opening is completely compromised, exposing the contents of the building to damage from the wind and wind carried debris.

Plywood shutters are often employed as a low cost method of protecting building openings. One method of installing plywood as a storm shutter is to attach the plywood across the face of the opening so that it overlaps the frame of the window or door. The plywood is then secured to the building or frame surface using fasteners. While using this method allows the plywood to be installed quickly during the period before a storm arrives, experience has shown that plywood shuttering installed using the overlapping method frequently fails, with the storm winds tearing the plywood away the building openings. When plywood shuttering is pulled free, the shuttering may become an instrument for causing damage by becoming a wind-driven projectile.

Plywood shuttering inset into the frame of the opening is more successful at withstanding removal by high winds. In the inset shuttering method, the plywood panels are cut to fit closely within the window frame. In a typical arrangement, the plywood panels are secured within the frame using fastening mechanisms that attach to the plywood and extend into the frame.

The requirement to attach fastening mechanisms to the plywood causes the installation of inset plywood shutters to require significant time and effort. Since the path of storms cannot be predicted with perfect accuracy, the amount of forewarning of an impending storm may be limited, and preparation time may be a valuable commodity when preparing for a storm. In addition, plywood is subject to weathering, and thus may have a limited useful life. When the plywood is replaced, hardware attached to the panels must be placed on new panels, causing a repeated expenditure of labor and effort.

Thus, a storm panel bracket system for securing storm panels solving the aforementioned problems is desired.

### SUMMARY OF THE INVENTION

The storm panel bracket system is a system for securing storm panels inset within the frame of building openings. The storm panel bracket system includes one or more storm brackets and one or more resilient bumpers. Each storm bracket includes an adjusting screw and adjustment nut. Turning the adjustment nut moves the nut along the adjusting screw. The movement of the nut moves a movable member of the storm bracket. The movable member holds a protecting storm panel and forces the panel against the frame of the window, providing a clamping action that holds the storm panel in place. The storm panel bracket system includes resilient bumpers that are placed between the storm panel and the frame to provide a cushion for the frame and to enhance friction between the frame and the storm panel.

The storm brackets are held in place against a frame of a building opening by forcing the base of the storm bracket against the frame. The lower surface of the base of the storm bracket may be provided with a resilient pad to cushion the frame and enhance friction with the frame of the opening. In another embodiment, friction enhancement may be provided by a tread pattern on the lower surface of the base.

In use, the resilient bumpers are placed between one edge of the storm panel and the frame while the storm brackets are placed between the opposite edge of the panel and the frame. For example, the resilient bumpers may be placed at the top edge of the frame, with the storm brackets being installed between the lower edge of the storm panel and the lower edge of the frame. The storm panel is held by a movable member of the storm bracket. The storm bracket is expanded by turning an adjusting member, which moves the movable member, forcing the edge of the panel into the bumpers installed between the frame and the storm panel. The force generated by the storm bracket generates a press fit that holds the storm panel within the frame of the opening.

These and other features of the present invention will become readily apparent upon further review of the following specification and drawings.

### BRIEF DESCRIPTION OF THE DRAWINGS

FIG. 1 is a front perspective view of a storm panel bracket system according to the invention used to install a storm panel over a window.

FIG. 2 is a top view of the storm panel bracket system of FIG. 1 securing a plywood storm panel inset in window frame.

FIG. 3A is a front perspective view of a storm panel bracket of the present invention in a retracted condition.

FIG. 3B is a front perspective view of a storm panel bracket of the present invention in an expanded condition.

Similar reference characters denote corresponding features consistently throughout the attached drawings.

### DETAILED DESCRIPTION OF THE PREFERRED EMBODIMENTS

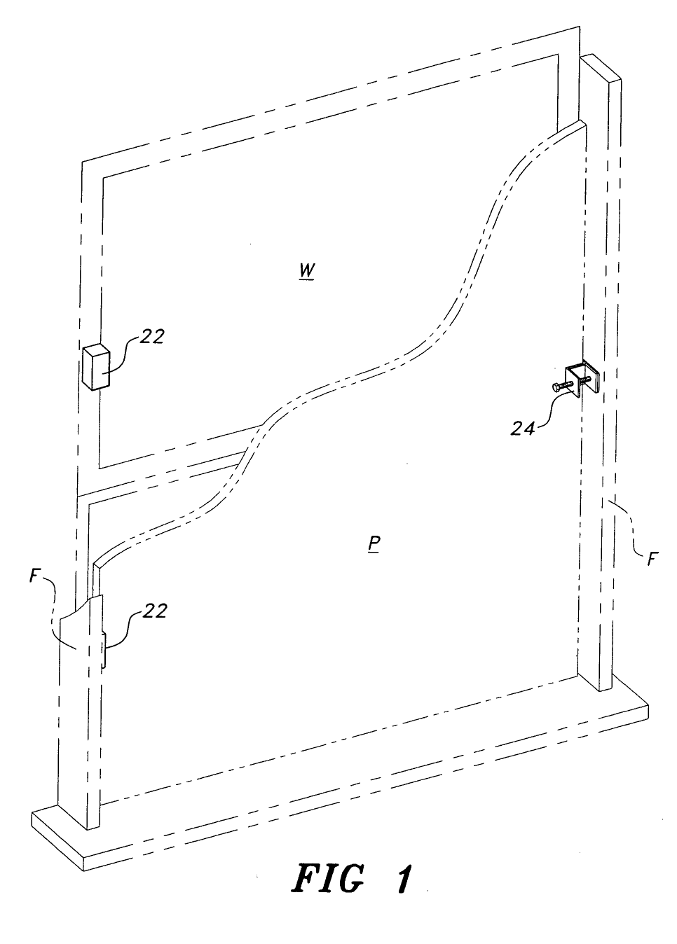

The present invention is a storm panel bracket system for securing storm panels to protect building openings. The system can be appreciated by referring to FIGS. 1, 2, 3A, and 3B.

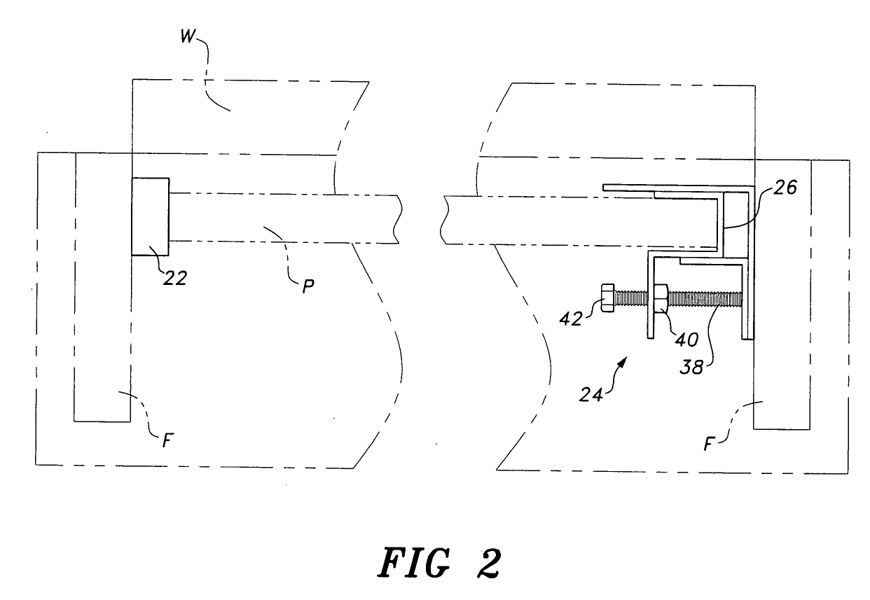

Referring first to FIGS. 1 and 2, the use of the storm panel bracket system of the present invention to protect a building opening may be appreciated. The storm panel bracket system comprises a storm panel bracket 24 and one or more resilient bumpers 22. A building opening, such as a window W, is protected by a plywood storm panel P. The plywood panel P is sized to fit within the frame F of the window W. The resilient bumpers 22 are placed between the panel P and one side of the window frame F, while the storm panel bracket 24 is installed between the panel and the window frame F at the opposite side of the window W. Adjusting the storm panel bracket 24, as described below, results in the storm panel bracket 24 forcing the storm panel P against the window frame F. The securing force generated by the storm panel bracket 24 produces a secure press fit between the storm panel P, the resilient bumpers 22, and the window frame F, holding the storm panel P in place against the force of storm winds.

Referring now to FIG. 2, additional details of the storm panel bracket system and its use may be appreciated. The storm panel P is in an inset position within the opening of frame F. The storm panel bracket 24 includes an adjustment nut 40 threaded onto a fixed adjustment screw 38. Turning the adjustment screw 38 selectively moves a movable member 26 of the storm panel bracket 24 in a horizontal direction, generating the securing force that drives the storm panel P into the resilient bumper 22 and holds the storm panel P in the inset position. A retaining head 42 at the top of the adjustment screw retains the movable member 26 on the storm panel bracket 24.

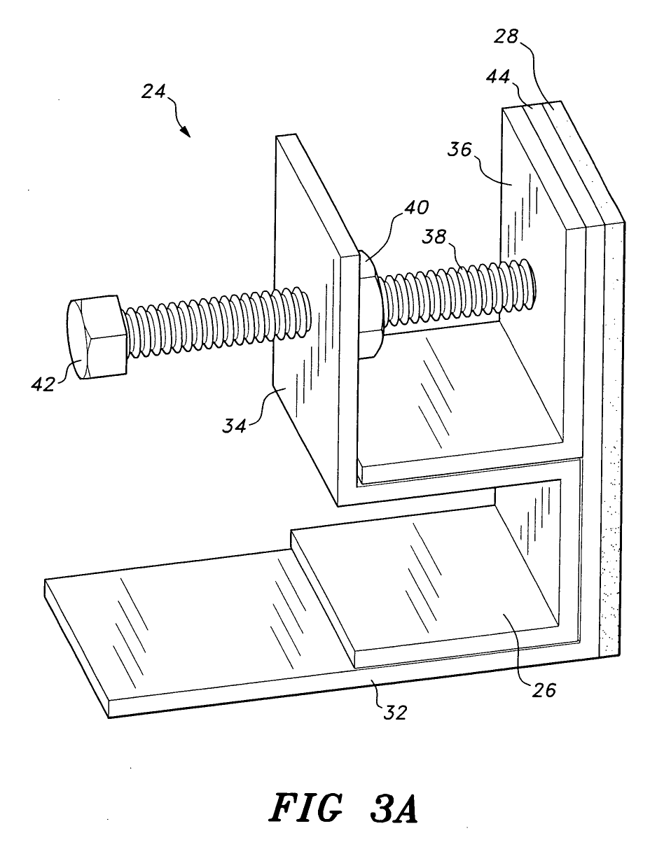

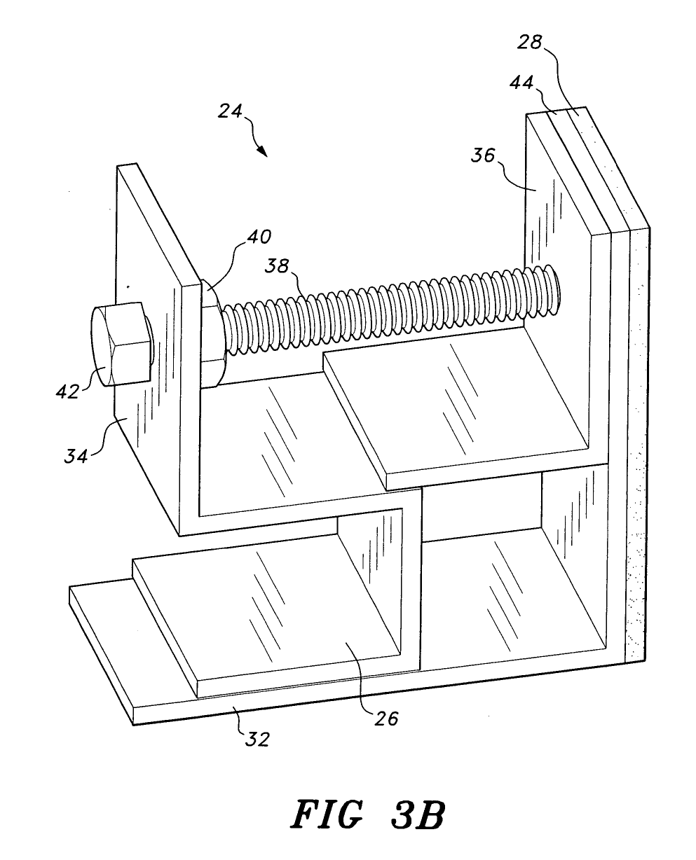

By referring now to FIGS. 3A and 3B, additional details of the storm panel bracket 24 and its use may be understood. The storm panel bracket 24 comprises a base member 44 that supports the other components of the bracket. Base member 44 is shown in the drawings as a large L-shaped shaped member 32 having a smaller L-shaped member 36 having one leg affixed to the larger L-shaped member 32, the other leg of the smaller L-shaped shaped member 36 being in parallel relation with the large L-shaped member 32 to define a channel. The lower surface (surface to be installed nearest the opening frame F) of the base member 44 is provided with a resilient pad 28. When the storm panel P is installed in the window or other building opening, the resilient base pad 28 bears against the frame of the opening. When the storm panel bracket 24 is operated to secure a window, the securing force generated by the storm panel bracket 24 presses the resilient base pad 28 against the window frame, generating a press fit that holds the storm panel bracket 24 in position.

The storm panel bracket 24 further comprises an adjustment screw 38. The adjustment screw 38 is mounted to a fixed surface of the storm panel bracket 24, such as the base 44. The adjustment screw 38 extends perpendicularly from the base 44, and may be welded thereto so that adjustment screw 38 does not rotate. An adjustment nut 40 threadably engages the adjustment screw 38. Rotating the adjustment nut 40 on the fixed adjustment screw 38 causes the adjustment nut 40 to move along the axis of the adjustment screw 38.

The storm panel bracket 24 further includes a movable positioning member 26. The movable positioning member 26 comprises a U-shaped body slidable in the channel defined by the base member 44 and having a plate 34 or flange extending laterally from one side of the mouth of the U-shaped body, the laterally extending plate 34 having a bore defined therein slidable on adjustment screw 38 between the head 42 of the adjustment screw 38 and nut 40.

FIG. 3A shows the storm panel bracket 24 in the fully retracted condition. When the adjustment nut 40 is rotated to expand the storm panel bracket, the adjustment nut 40 moves on the adjustment screw 38 in the direction away from the bracket base 44, moving the plate 34 away from the base 44. As best appreciated by referring to FIG. 3B, which shows the storm panel bracket 24 in the fully expanded condition, screw head 42 limits the travel of the movable member 26 and retains the movable member 26 and the adjustment nut 40 on the adjustment screw 38.

The lower portion of the movable member 26 is provided with a panel holding means. The panel holding means is the U-shaped portion of movable member 26, which is dimensioned and configured for receiving an edge of the plywood storm panel P. As best shown in FIG. 2, the edge of a storm panel P slidably engages the channel formed by the U-shaped portion of movable member 26. Adjusting the adjustment nut to move the movable member 26 away from the base of the storm panel bracket 24, forces the storm panel P into the rubber bumper 22 installed on the side of the storm panel P opposite the storm panel bracket 24.

The components of the storm panel bracket system may be installed in various combinations as required to protect openings of various sizes. As shown in FIG. 1, for small windows a single bracket 24 may be centered vertically within the opening frame F at one side of the opening to be protected W. One or more rubber bumpers 22 are positioned between the storm panel P and the opening frame F at the other side of the opening W. Preferable a plurality of bumpers 22 is provided, with the bumpers 22 being distributed along the vertical edge of the storm panel P.

For openings having a relatively large vertical dimension, a plurality of storm brackets 24 is used, with the brackets 24 being distributed vertically along an edge of the storm panel P.

The storm bracket movable and supporting members may be made of any sufficiently strong material. For example, the storm bracket base 44, L-shaped guides 32 and 36, and movable member 26 may be made of metal, such as sheet steel or extruded aluminum. The resilient bumpers 22 and the resilient pad 28 may be made of any resilient, friction enhancing or cushioning material, such as rubber or neoprene.

It is to be understood that the present invention is not limited to the embodiments described above, but encompasses any and all embodiments within the scope of the following claims.

We claim:

1. A storm panel bracket for holding a storm panel, comprising:
a supporting base defining a U-shaped guide channel and an adjustment screw mounting plate extending adjacent the guide channel;
an adjusting screw having a shaft fixed to the mounting plate, the screw extending parallel to the guide channel and having a head at an end of the shaft opposite the mounting plate;
an adjusting nut threadedly engaging the adjusting screw;
a movable member having:
a U-shaped portion dimensioned and configured for receiving an edge of a storm panel, the U-shaped portion being slidable in the guide channel; and
a plate extending lateral to one side of the mouth of the U-shaped portion, the laterally extending plate having a bore defined therein surrounding the shaft of the adjusting screw, the laterally extending plate being slidable between the adjusting nut and the head of the adjusting screw.

2. The storm panel bracket as recited in claim 1, further comprising a resilient pad secured to the supporting base, the resilient pad being adapted for frictional engagement with a window frame.

3. The storm panel bracket according to claim 2, wherein said resilient pad comprises a pad made from rubber.

4. The storm panel bracket according to claim 2, wherein said resilient pad comprises a pad made from neoprene.

5. A storm panel bracket system, comprising:
a storm panel bracket having:
a supporting base defining a U-shaped guide channel and an adjustment screw mounting plate extending adjacent the guide channel;
an adjusting screw having a shaft fixed to the mounting plate, the screw extending parallel to the guide channel and having a head at an end of the shaft opposite the mounting plate;
an adjusting nut threadedly engaging the adjusting screw;
a movable member having:
a U-shaped portion dimensioned and configured for receiving an edge of a storm panel, the U-shaped portion being slidable in the guide channel; and
a plate extending lateral to one side of the mouth of the U-shaped portion, the laterally extending plate having a bore defined therein surrounding the shaft of the adjusting screw, the laterally extending plate being slidable between the adjusting nut and the head of the adjusting screw; and
at least one resilient bumper adapted for attachment to the storm panel on an edge opposite the storm panel bracket.

6. The storm panel bracket system as recited in claim 5, further comprising a resilient pad secured to the supporting base, the resilient pad being adapted for frictional engagement with a window frame.

7. A method of securing a storm panel within a frame of a building opening, comprising the steps of:
(a) providing a storm panel bracket system according to claim 5;
(b) positioning the at least one resilient bumper between a first edge of the storm panel and a first side of the frame;
(c) positioning said storm bracket between a second edge of the storm panel and a second side of the frame, the second edge of the storm panel being opposite to the first edge of the storm panel, the second edge of the storm panel being lodged in the U-shaped portion of said movable member; and
(d) turning the adjustment nut to force the first edge of the storm panel against the first side of the frame.
